(19) United States
(12) Patent Application Publication
(10) Pub. No.: US 2019/0382116 A1
(43) Pub. Date: Dec. 19, 2019

(54) DRUG SPREADING DRONE

(71) Applicant: NILEWORKS INC., Tokyo (JP)

(72) Inventor: Hiroshi YANAGISHITA, Tokyo (JP)

(21) Appl. No.: 16/481,523

(22) PCT Filed: Jan. 27, 2018
(86) PCT No.: PCT/JP2018/002600

§ 371 Date: Jul. 29, 2019

(30) Foreign Application Priority Data
Jan. 30, 2017 (JP) 2017-014924

(51) Int. Cl. B64D 1/18; B64C 39/02; B64C 27/82; A01M 7/00; B05B 13/00

(52) U.S. Cl. CPC B64D 1/18; B64C 39/024; B64C 27/82; B64C 2201/027; B05B 13/005; B64C 2201/128; A01M 7/0042

(57) ABSTRACT

PROBLEM: To provide a chemical spraying drone (unmanned air vehicle) in which minimizes chemical drift outside the field by a simple structure without additional equipment and complicated control.

SOLUTION: To provide a chemical spraying drone that actively uses the air flow made by rotors for spraying, comprising chemical spray nozzles and rotors (preferably two-stage rotors), wherein the chemical spray nozzles are positioned under the rotors and under a circular area with its center at a point offset by a predetermined distance rearward with respect to the flying direction from the rotor's rotation axis, its radius 90 percent of the radius of the rotor blade, on a straight line with a depression angle of about 60 degrees rearward from the horizontal line passing through the rotor's rotation axis. The position of the chemical spray nozzles may be dynamically adjusted.

### TECHNICAL FIELD

The present invention relates to an unmanned air vehicle (drone) that sprays chemicals such as pesticides, and more particularly to the one that can minimize undesirable drift of chemicals outside the field even if the field is narrow or with a complex shape.

### BACKGROUND ART

Applications of remote-controlled small unmanned air vehicle generally called drone are spreading. Among those applications, an important one is the drone that sprays chemicals such as pesticides and liquid fertilizers to farmlands (for example, see Patent Document 1 below). In Japan where farmland field is not so wide compared to the West, the use of drones rather than manned planes and helicopters is often desirable.

Chemical spraying by a drone is advantageous because of being able to spray the chemical efficiently and accurately even on farmland with narrow and complex terrain which is typical in Japan. Thanks to the technologies such as QZSS (Quasi-Zenith Satellite System) and RTK-GPS (Real Time Kinematic Global Positioning System), it is now possible for a drone to know its absolute position by centimeter precision during flight. If the exact shape of farmland is obtained, precise flying for chemical spraying will be possible.

However, even if the drone can fly over the field precisely, with other factors such as wind, the problem of the chemical being scattered outside of the field remains. It is particularly important to avoid such cases that pesticide scatters on pesticide-free crops outside the field and that herbicide scatters on cultivation plants outside the field. Conventional drones have not been able to cope with this problem effectively. There was a technology to adjust the flying route of a drone depending on the wind direction and force with the drone equipped with sensors (for example, see Patent Document 2 below), but the control precision and complexity of the mechanism were problematic, especially when it was applied to narrow fields.

### PRIOR ART DOCUMENTS

### Patent Document

Patent Document 1: Japanese Patent Application Publication 2001-120151.

Patent Document 2: Japanese Patent Application Publication 2006-176073.

### SUMMARY OF INVENTION

### Problems to Be Solved by the Invention

To provide a chemical spraying drone (unmanned air vehicle) with minimal drift out of the field.

### Means for Solving the Problem

The present invention provides a chemical spraying unmanned aerial vehicle comprising: a plurality of chemical spray nozzles; and a plurality of rotors, wherein: among the plurality of the rotors, a set of rotors positioned above and under and rotating in opposite directions constitute a first counter-rotating blades; and at least one of the chemical spray nozzles is positioned under the a first counter-rotating blades in order to solve the above problem.

Further, The present invention provides a chemical spraying unmanned aerial vehicle according to Paragraph 0007: wherein; among the plurality of rotors, a set of rotors located above and under and adjacent to the first counter-rotating blades constitute a second counter-rotating blades; and a chemical spray nozzle is not located under the second counter-rotating blades in order to solve the above problem.

Further, the present invention provides A chemical spraying unmanned aerial vehicle according to Paragraph 0007, wherein: the second counter-rotating blades are located directly behind the first counter-rotating blades with respect to a flying direction of the vehicle in order to solve the above problem.

Further, the present invention provides a chemical spraying unmanned aerial vehicle according to Paragraph 0007, Paragraph 0008 or Paragraph 0009, wherein: the first counter-rotating blades is located in front with respect to a flying direction of the vehicle in order to solve the above problem.

Further, the present invention provides a chemical spraying unmanned aerial vehicle according to Paragraph 0007, Paragraph 0008, Paragraph 0009 or Paragraph 0010, wherein: the chemical spray nozzles under the first counter-rotating blades are located under a circular area with its center offset by a offset distance forward or backward from the center of the first counter-rotating blades and its radius is smaller than a radius of the first counter-rotating blades in order to solve the above problem.

Further, the present invention provides a chemical spraying unmanned aerial vehicle according to Paragraph 0007, Paragraph 0008, Paragraph 0009, Paragraph 0010 or Paragraph 0011, wherein: the chemical spray nozzle under the first counter-rotating blade is under an area surrounded by a first circle and a second circle, the center of the first circle being offset by the offset distance forward or backward from the center of the first counter-rotating blades, the radius of the first circle being more than 50 percent of the radius of the first counter-rotating blade, the center of the second circle being offset by the offset distance forward or backward from the center of the first counter-rotating blades, and the radius of the second circle being less than 90 percent of the radius of the first counter-rotating blade in order to solve the above problem.

Further, the present invention provides a chemical spraying unmanned aerial vehicle according to Paragraph 0011 or Paragraph 0012, further comprising: a mechanism for adjusting the offset distance according to the flight speed of the vehicle or the chemical discharge speed in order to solve the above problem.

Further, the present invention provides a chemical spraying unmanned aerial vehicle according to Paragraph 0011, Paragraph 0012 or Paragraph 0013 wherein: the center of the circular area is adjusted to move forward as the vehicle flight speed increases or chemical discharge speed increases in order to solve the above problem.

Further, the present invention provides a chemical spraying unmanned aerial vehicle according to Paragraph 0011, Paragraph 0012 or Paragraph 0013, wherein: the center of the circular area is located rearward of the center of the rotor by an offset distance; and the higher the vehicle flight speed or the chemical discharge speed is, the less the offset distance is in order to solve the above problem.

Further, the present invention provides a chemical spraying unmanned aerial vehicle according to Paragraph 0011, Paragraph 0012, Paragraph 0013, Paragraph 0014 or Paragraph 0015 further comprising: a mechanism to adjust position of the center of the circular region, according the flight speed of the vehicle at the time of spraying or chemical spraying speed in order to solve the above problem.

Further, the present invention provides a chemical spraying unmanned aerial vehicle according to Paragraph 0007, Paragraph 0008, Paragraph 0009, Paragraph 0010, Paragraph 0011, Paragraph 0012, Paragraph 0013, Paragraph 0014, Paragraph 0015 or Paragraph 0016, wherein: a vertical distance between the first counter-rotating blade and the chemical spray nozzle located under the first counter-rotating blade is equal to or less than a radius of the first counter-rotating blades in order to solve the above problem.

Further, the present invention provides a chemical spraying unmanned aerial vehicle according to Paragraph 0011, Paragraph 0012, Paragraph 0013, Paragraph 0014, Paragraph 0015, Paragraph 0016 or Paragraph 0017, wherein: the offset distance is adjusted so that a depression angle to the nozzle from a horizontal line toward backward with respect to the flying direction of the vehicle is 60 degrees in order to solve the above problem.

Further, the present invention provides a chemical spraying unmanned aerial vehicle according to Paragraph 0018, wherein: the depression angle was adjusted to a smaller angle as the flight speed of the vehicle is faster, or chemical discharge speed is higher in order to solve the above problem.

Further, the present invention provides a chemical spraying unmanned aerial vehicle according to Paragraph 0018 or Paragraph 0019, further comprising: a mechanism for adjusting the depression angle according to the flying speed of the vehicle or chemical spraying speed in order to solve the above problem.

Further, the present invention provides a chemical spraying unmanned aerial vehicle according to Paragraph 0007, Paragraph 0008, Paragraph 0009, Paragraph 0010, Paragraph 0011, Paragraph 0012, Paragraph 0013, Paragraph 0014, Paragraph 0015, Paragraph 0016, Paragraph 0017, Paragraph 0018, Paragraph 0019 or Paragraph 0020, wherein: plurality of spray nozzles are positioned at substantially equal intervals in a horizontal direction when viewed from the direction of travel of the vehicle in order to solve the above problem.

Further, the present invention provides a chemical spraying unmanned aerial vehicle according to Paragraph 0007, Paragraph 0008, Paragraph 0009, Paragraph 0010, Paragraph 0011, Paragraph 0012, Paragraph 0013, Paragraph 0014, Paragraph 0015, Paragraph 0016, Paragraph 0017, Paragraph 0018, Paragraph 0019, Paragraph 0020 or Paragraph 0021, further comprising: a mechanism for controlling a direction of the vehicle such that first counter-rotating blades are always in front in the flying direction when the flying direction changes in order to solve the above problem.

### Advantageous Effect of the Invention

Even in a field of complex shape which is typical in Japan, precise chemical spraying is possible with drift outside the field minimized.

### BRIEF DESCRIPTION OF THE DRAWING

FIG. 1 This is a plan view of an embodiment of a chemical spraying drone according to the present invention.

FIG. 2 This is a front view of an embodiment of a chemical spraying drone according to the present invention.

FIG. 3 This is a right side view of an embodiment of a chemical spraying drone according to the present invention.

FIG. 4 This is an experimental result and its explanatory diagram showing the intensity of the airflow under the rotor of a drone.

FIG. 5 This is an explanatory diagram explaining appropriate positions of nozzles of a chemical spraying drone according to the present invention.

FIG. 6 This is a diagram showing optimal position of the nozzles of an embodiment of the chemical spraying drone according to the present invention.

FIG. 7 This a diagram showing other examples of the position of the nozzles of an embodiment of the chemical spraying drone according to the present invention.

FIG. 8 This a diagram showing other examples of the optimal control of a flight direction of an embodiment of the chemical spraying drone according to the present invention.

### DESCRIPTION OF EMBODIMENTS

Hereinafter, embodiments of the present invention will be described with reference to the drawings. The figures are all exemplary.

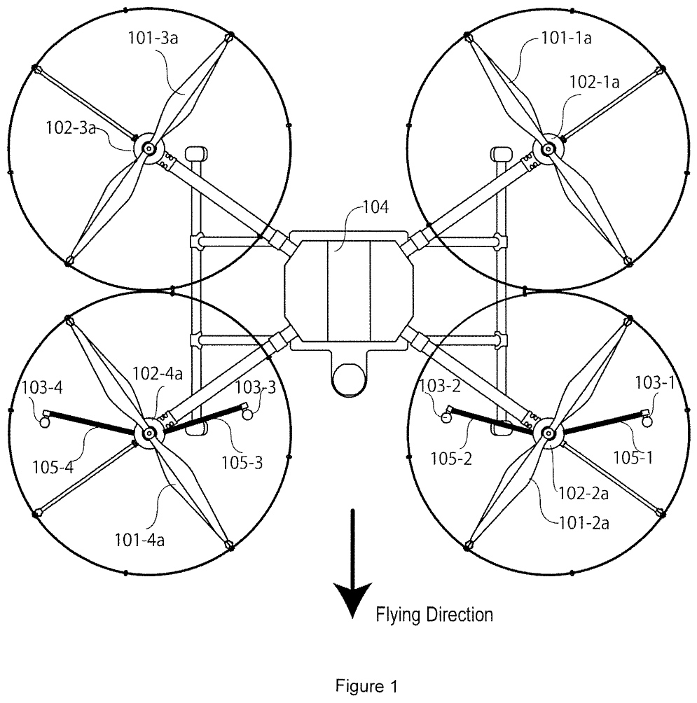

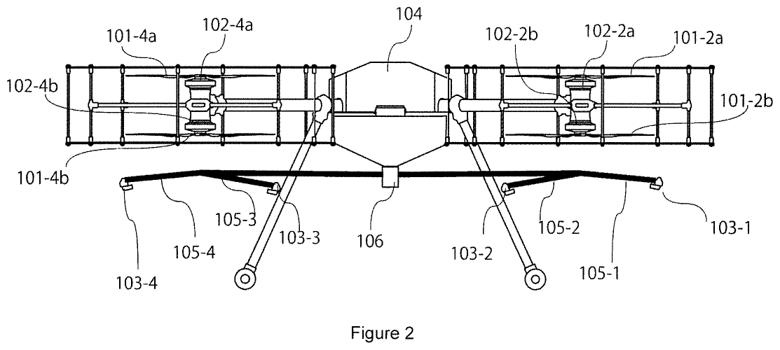

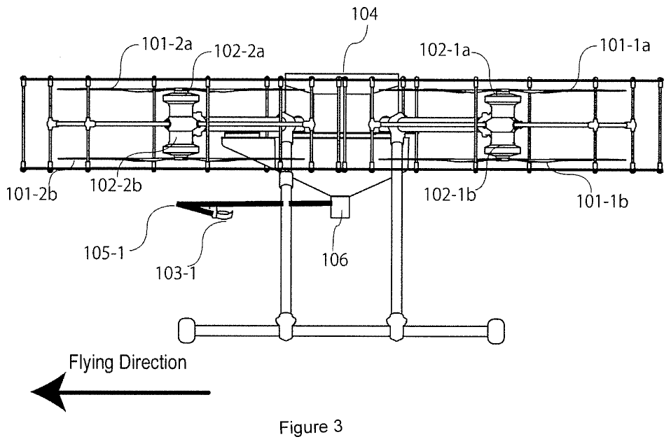

FIG. 1 shows a plan view of an embodiment of a chemical spraying drone according to the present invention. FIG. 2 shows a front view thereof (as viewed from the flying direction) and FIG. 3 shows a right side view thereof. In the present specification, a drone may mean any unmanned air vehicle having a plurality of rotors, regardless of power source (electric motor, engine, etc.) and a control system (wireless or wired, autonomous flight type or manual operation type, etc.).

Rotor blades (also called “rotors”) (101-1a, 101-1b, 101-2a, 101-2b, 10 1-3a, 101-3b, 101-4a, 101-4b) are means causing a drone to fly. It is desirable that eight rotors (four sets of two-stage rotors) are provided, for the sake of flight stability, airframe size limitation, and optimal battery consumption. (Hereinafter, a pair of an upper rotor and its corresponding lower rotor may be called “set”).

Motors (102-1a, 102-1b, 102-2a, 102-2b, 102-3a, 102-3b, 102-4a, 102-4b) are means for rotating the rotor blades. They are typically electric motors but can be combustion engines or the like. Preferably, one motor is provided for each rotor. The upper and lower rotors (e.g., 101-1a and 101-1b) and their corresponding motors (e.g., 102-1a and 102-1b) in the set are preferably aligned concentrically and rotated in the opposite direction in order to increase flight stability of the drone and maximize the effect of preventing pesticide drift out of the field (explained later). Although some rotors (101-3b) and the motor (102-3b) are not shown in the figures, their positions are self-explanatory, and if there is a left-side view, their positions would be shown.

Spray nozzles (103-1, 103-2, 103-3, 103-4) are means for spraying chemicals downward to the farmland field. Preferably, four nozzles are provided. In this specification, chemical shall refer to any liquid or powder material to be sprayed to farmland fields, including pesticide, agrochemical, herbicide, liquid fertilizer, insecticide, and water. While, in conventional drones, the nozzles were usually positioned to avoid influence of the swirling flow created by the rotors, in the drone according to the present invention, all the spray nozzles (103-1, 103-2, 103-3, 103-4) are preferably positioned directly under the rotor blade sets on the front side of the flying direction (a set consisting of 101-2a and 101-2b, and a set consisting of 101-4a and 101-4b). This is to minimize undesired drift of the chemical by actively utilizing the downward wind force made by the rotor blades. Further, in conventional drones, it was usual that there was a certain distance between rotor blades and spray nozzles (typically, approximately equal the diameter of the rotor blades) to minimize the impact by rotation of the rotor blades. On the other hand, in the drone according to the present invention, the distance between the rotor blade and the spray nozzle is much closer (preferably, about 30 percent of the diameter of the rotor blades). This is to actively utilize the air flow made by the rotors. This fact was discovered by experiments by the inventor. More details on the position of the spray nozzles will be described later.

A reservoir (104) is a mean for storing chemical to be sprayed by the drone. Preferably, it is positioned close to the center of gravity of the drone for the sake of weight balance. Chemical hoses (105-1, 105-2, 105-3, 105-4) connect the reservoir (104) and each spray nozzle (103-1, 103-2, 103-3, 103-4). They may be made of a firm material, serving to support the spray nozzles. A pump (106) is a mean for spraying the chemical from the nozzles. In addition to the above, the drone according to the present invention preferably are provided with a computer device for controlling flight, a wireless communication device for remote control, a GPS device for position detection, and a battery and the like, which are not shown in the figures. The drone according to the present invention preferably includes RTK-GPS that can accurately measure its position. This is because the purpose of the present invention to minimize the chemical drift becomes more effectively achieved by being able to fly above peripheral parts of the field precisely. In addition, common components necessary for drones, such as legs required for landing, a frame for maintaining the motor, and a safety frame for preventing human hands from touching the rotors are illustrated in the figures, but they are self-explanatory and will not be described further.

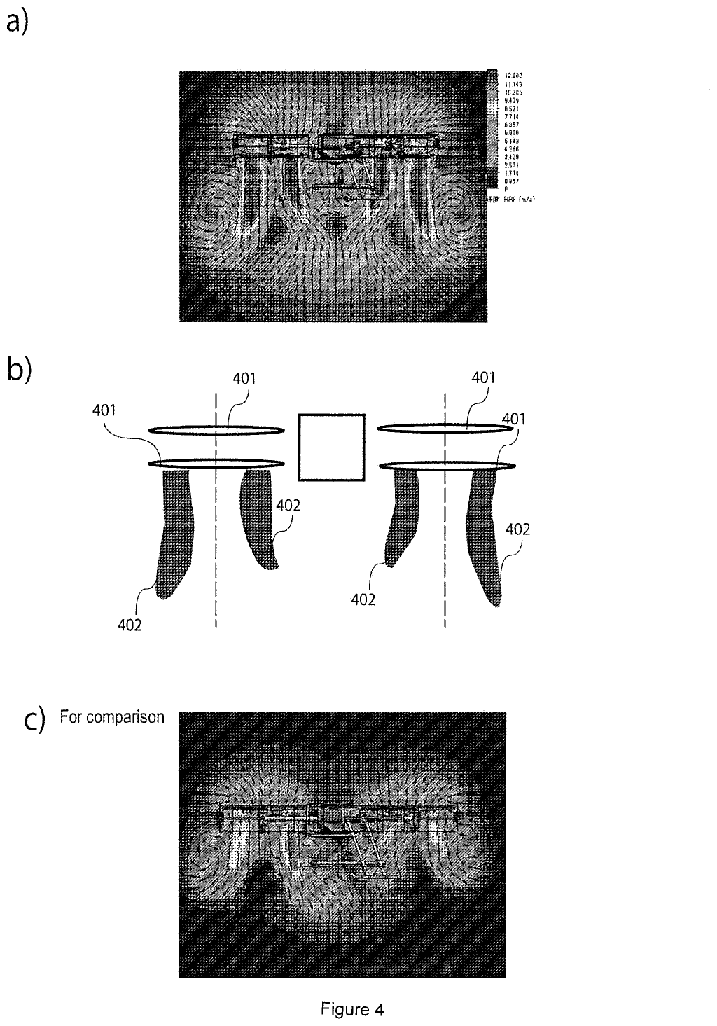

As shown in FIG. 4-a, according to the inventor's experiments, under rotor blades of a two stage rotor configuration, as viewed from above, there is a cylindrical region with a high velocity air flow between approximately 50% and 90% of the radius from the center of the rotor blade. FIG. 4-b is a schematic view of FIG. 4-a, and a rotary blade (401) is a schematic view of the rotary blade described in FIG. 1, FIG. 2 and FIG. 3. Typically, the wind speed at this cylindrical area (402) is more than 10 meters per second when the diameter of the rotor is 70 centimeters, the rotation speed is 2,000 revolutions per minute and the drone body weight is 20 kilogram. By placing a spray nozzle in this cylindrical region, it is apparent from the inventors experiment that this cylindrical area acts as a “protective wall”, minimizing undesired chemical drift. FIG. 4-c shows the experimental result with the drone of the single-stage rotor configuration for comparison. A cylindrical region with a high velocity air is not clear as compared with the case of the two-stage rotor configuration. Moreover, in the experiment by the inventor, it has been revealed that in the case of the single-stage rotor configuration, the undesirable chemical drift out of the field is rather increased by the influence of the rotational air flow made by the rotor. Therefore, to maximize the effects of the present invention, it is desirable to use a two-stage rotor configuration. Furthermore, by using the two-stage rotor configuration, turbulence in the downward air flow can be reduced and the air flow speed can be maintained high, so that the chemical can be effectively sprayed even to the root part of the crop. In order to actively use the air flow created by the rotor blades of the drone according to the present invention, it is preferable that the drone flies low in the air (typically, about 75 centimeters from the top of the field crop) to make the downward air speed about 7 meter per second.

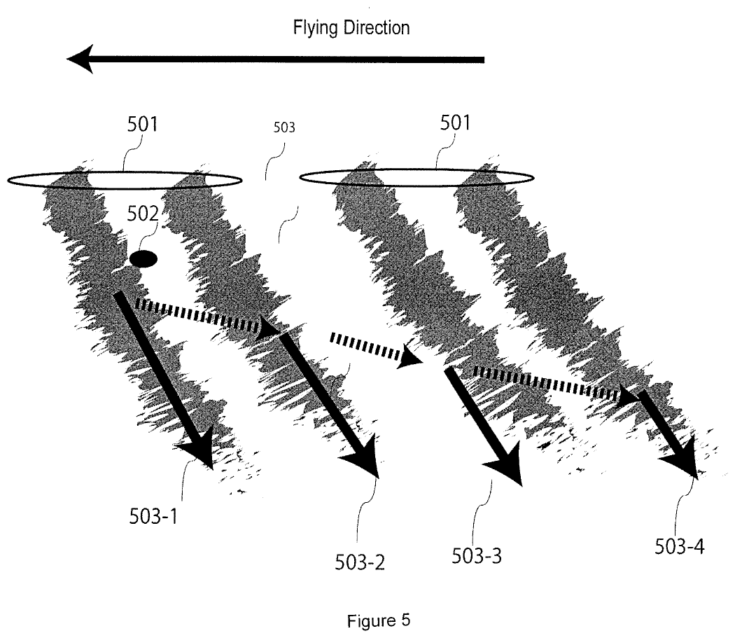

FIG. 5 shows the principle that drift of the chemical can be minimized with the position of the spray nozzles of the drone according to the present invention, which was discovered by the experiments by the inventor. FIG. 5 is a schematic view (a sectional view by a plane passing through the central axis of the rotors) of the drone shown in FIG. 1, FIG. 2 and FIG. 3. When the drone moves forward, the cylindrical region of high velocity air flow shown in FIG. 4 tilts rearward with regard to the flying. It is preferable to place the spray nozzles (502) inside this tilted cylindrical area and under the front side rotors with regard to the flying direction. In this way, the chemical is sprayed efficiently (while minimizing undesirable drift) by riding the first downward air flow (503-1) of the drone. Some of the chemical drifts backward but is efficiently sprayed downward by riding the second downward air flow (503 -2) downward. Likewise, the third air stream (503-3) and the fourth air stream (503-4) can also be used to spray the chemical under the drone while minimizing undesired drift (scattering) of the chemical.

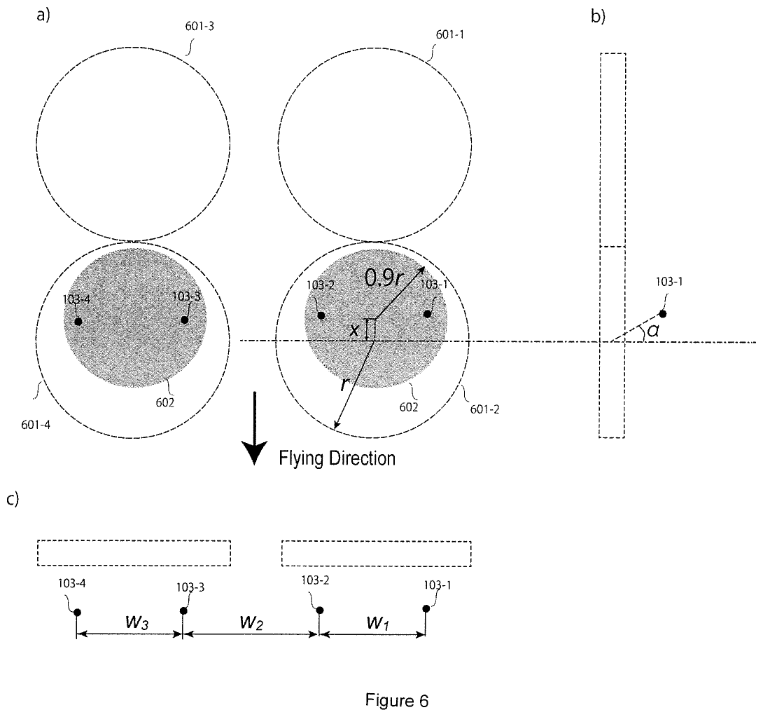

FIG. 6 shows preferred position of the spray nozzles (103-1,103-2,103-3 and 103-4) of the drone according to the present invention in detail, based on the experimental results shown in FIG. 4 and FIG. 5 (FIG. 6-a is a plan view, FIG. 6-b is a right view, and FIG. 6-c is a front view). 601-1, 602-2, 601-3, and 604-4 are schematic representation of the rotational ranges of the four rotor blade sets (which correspond to, respectively, 101-1a and 101-1b, 101-2a and 101-2b, 101-3a and 101-3b, and 101-4a and 101-4b in FIG. 1).

As shown in FIG. 4, it is a cylindrical region located at a position between 50% and 90% of the radius from the center of the rotor blades where strong downdraft is created. However, as shown in FIG. 5, as the drone flies, the cylindrical region tilts rearward with regard to the flying direction. Therefore, it is preferable to locate the spray nozzles (103-1, 103-2) under a region (602) within a circle having a radius of approximately 90% of the radius (r) of the rotor, centered on a position shifted rearward with regard to the flying direction by a predetermined distance (x) from the center of the rotor (preferably under the circumference of a circle with a radius approximately 70% of the radius (r) of the rotor). The same applies to other blades 103-3 and 103-4, but is it not shown for simplicity.

The offset distance (x) of the circle center should be such that tan(α) (tangent of alpha) equals to v1/v2 (v1 divided by v2), wherein α (alpha) is the angle shown in FIG. 6-b, v1 is the flying speed of the drone, and v2 is the velocity of downward air flow made by the rotor. This is to make the angle alpha substantially equal to the rearward inclination of the fast downward air flow region shown in FIG. 5. In a typical design, v1=5 m/sec (five meters per second), v2=10 m/sec (ten meters per second), α (alpha)=30 degrees (60 degrees in terms of the depression angle from the horizontal line). In practice, α (alpha) may be from 20 degrees to 40 degrees. Typically, as the vertical distance between the rotor and the spray nozzle is about 20 centimeter and α (alpha) is about 30 degree, and the offset distance of the center (x) is about 10 centimeters.

In addition, as shown in FIG. 6-c, it is preferable to make the distances (w1, w2, and w3) between the spray nozzles viewed from the front in the flying direction of the drone as equal as possible for uniform distribution of the chemical.

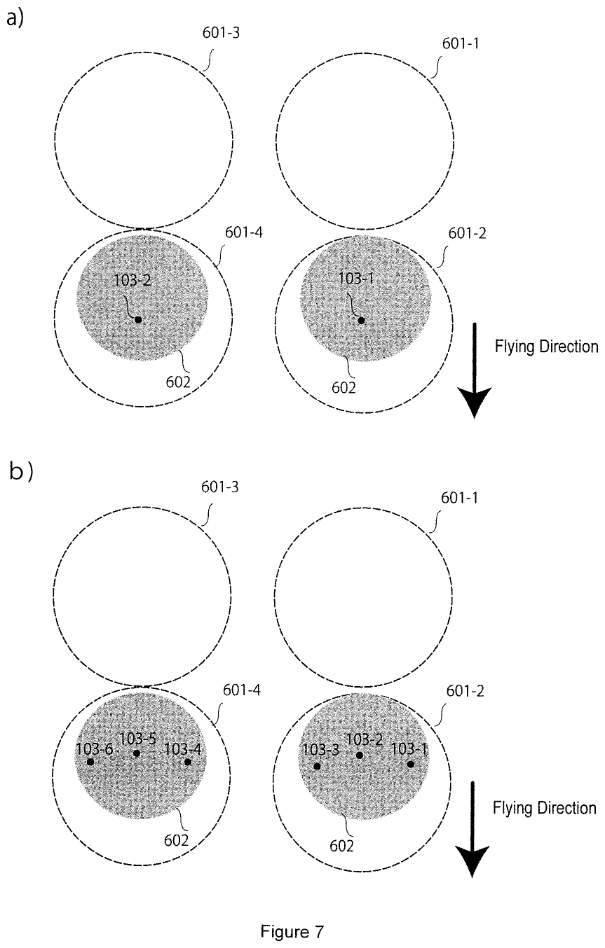

FIG. 7 shows other examples of the position of the spray nozzles (103) of the drone according to the present invention. FIG. 7-a shows an example in which two spray nozzles (103-1 and 103-2) are used, and the spray nozzle is placed near the center axis of the rotor blades on the front side with regard to the flying direction (the position may be shifted to the rear). FIG. 7-b shows an example in which six spray nozzles (103-1, 103-2, 103-3, 103-4, 103-5, 103-6) are used. In any case, according to the above-described principle, the downdraft generated by the rotor blades can be actively utilized to perform efficient chemical dispersion with undesirable drift minimized. The position of the spray nozzles (103) can be determined in the same way even when more spray nozzles (103) and more rotor blades are used.

The position of the spray nozzles may be manually adjusted by the user, depending on the flying speed of the drone, the wind direction, and the discharge speed of the chemical. The position of the spray nozzles may be adjusted by remote control using a mechanism such as a stepping motor and a wireless communication. The drone may be provided with a speed sensor (or speed measurement means by GPS or the like) so that the positions of the spray nozzles can be automatically adjusted according to the flying speed. That is, when the flight speed is high, the position of the spray nozzles may be adjusted so that the angle α (alpha) in FIG. 6 increases. In addition, the positions of the spray nozzles may be automatically adjusted in accordance with the discharge speed of the chemical. That is, when the discharge speed is high, the position of the spray nozzles can be adjusted so that the angle α (alpha) in FIG. 6 increases. In addition to the above, adjustment may take the rotational speed of the rotor blades into account. For example, when the rotational speed of the rotor blades is fast, adjustment of the degree alpha according to the flight speed may be moderated. Also, an anemometer may be provided on the drone so that the positions of the spray nozzles can be adjusted automatically according to the wind direction and the wind force. For example, in the case of head wind, the spray nozzles may be moved forward, and, in the case of tail wind, the spray nozzles may be moved backward. Further, the positions of the spray nozzles may be automatically adjusted in accordance with the amount of chemical sprayed from the spray nozzles (or, working rate of the pump). For example, when the amount of chemical sprayed from the spray nozzles, adjustment of the position of the spray nozzles may be more precise.

Optionally, a computer-controlled spraying may be implemented such that only spray nozzles directly under the rotor blade sets in front of the flying direction are working and the ones directly under the rotor blade sets in front of the flying direction are not working.

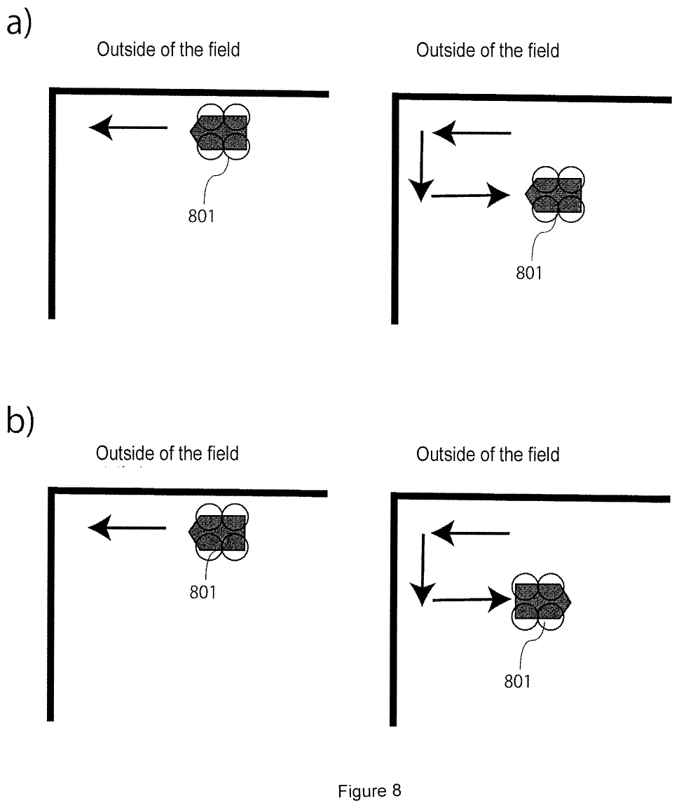

Optionally, control of direction changes as shown in FIG. 8 may be implemented. The drone (801) shown in FIG. 8 is a schematic representation of the drone described in FIG. 1, FIG. 2 and FIG. 3. In conventional drones, as shown in FIG. 8-a, when the drone (801) turns, only the flight direction is changed while the orientation of the airframe is maintained. In this case, if the drone is equipped with the function of adjusting the position of the spray nozzles, the position of the spray nozzles may be re-adjusted in accordance with the change in the flight direction. However, as shown in FIG. 8-b, the drone (801) according to the present invention can change the direction of the airframe toward the flight direction, so that a function to re-adjust the position of the spray nozzles as described above or a function to switch among the multiple spray nozzles are not necessary.

### Significant Technical Effects of the Present Invention

By using the drone according to the present invention, it is possible to perform precise chemical spraying with minimal drift (scattering) outside the field even in a narrow field of a complex shape typical in Japan. In the prior art, it was necessary to take a compromise not to fly near the boundary of the field in order to prevent the chemical drift outside field. In particular, when the wind is strong, the flight route was restrictive. With a drone according to the present invention, such a compromise is not necessary. Furthermore, additional equipment or complicated control mechanism is not necessary, since it is possible to achieve the above objective by a simple configuration. Therefore, it is advantageous in terms of cost compared to the conventional technologies.

1. A chemical spraying unmanned aerial vehicle comprising:
a plurality of chemical spray nozzles; and
a plurality of rotors,
wherein:
among the plurality of the rotors, a set of rotors positioned above and under and rotating in opposite directions constitute a first counter-rotating blades;
and at least one of the chemical spray nozzles is positioned under the first counter-rotating blades.

2. A chemical spraying unmanned aerial vehicle according to claim 1:
wherein:
among the plurality of rotors, a set of rotors located above and under and adjacent to the first counter-rotating blades constitute a second counter-rotating blades; and
a chemical spray nozzle is not located under the second counter-rotating blades.

3. A chemical spraying unmanned aerial vehicle according to claim 1:
wherein:
the second counter-rotating blades are located directly behind the first counter-rotating blades with respect to a flying direction of the vehicle.

4. A chemical spraying unmanned aerial vehicle according to claim 1, claim 2 or claim 3 wherein:
the first counter-rotating blades is located in front with respect to a flying direction of the vehicle.

5. A chemical spraying unmanned aerial vehicle according to claim 1, claim 2, claim 3 or claim 4 wherein:
the chemical spray nozzles under the first counter-rotating blades are located under a circular area with its center offset by an offset distance forward or backward from the center of the first counter-rotating blades and its radius is smaller than a radius of the first counter-rotating blades.

6. A chemical spraying unmanned aerial vehicle according to claim 1, claim 2, claim 3, claim 4 or claim 5 wherein:
the chemical spray nozzle under the first counter-rotating blade is under an area surrounded by a first circle and a second circle,
the center of the first circle being offset by the offset distance forward or backward from the center of the first counter-rotating blades,
the radius of the first circle being more than 50 percent of the radius of the first counter-rotating blade,
the center of the second circle being offset by the offset distance forward or backward from the center of the first counter-rotating blades, and
the radius of the second circle being less than 90 percent of the radius of the first counter-rotating blade.

7. A chemical spraying unmanned aerial vehicle according to claim 5 or claim 6 further comprising:
a mechanism for adjusting the offset distance according to the flight speed of the vehicle or the chemical discharge speed.

8. A chemical spraying unmanned aerial vehicle according to claim 5, claim 6 or claim 7 wherein:
the center of the circular area is adjusted to move forward as the vehicle flight speed increases or chemical discharge speed increases.

9. A chemical spraying unmanned aerial vehicle according to claim 5, claim 6 or claim 7 wherein:
the center of the circular area is located rearward of the center of the rotor by an offset distance; and
the higher the vehicle flight speed or the chemical discharge speed is, the less the offset distance is.

10. A chemical spraying unmanned aerial vehicle according to claim 5, claim 6, claim 7, claim 8 or claim 9 further comprising:
a mechanism to adjust position of the center of the circular region, according the flight speed of the vehicle at the time of spraying or chemical spraying speed.

11. A chemical spraying unmanned aerial vehicle according to claim 1, claim 2, claim 3, claim 4, claim 5, claim 6, claim 7, claim 8 or claim 9 wherein:
a vertical distance between the first counter-rotating blade and the chemical spray nozzle located under the first counter-rotating blade is equal to or less than a radius of the first counter-rotating blades.

12. A chemical spraying unmanned aerial vehicle according to claim 5, claim 6, claim 7, claim 8, claim 9, claim 10 or claim 11 wherein:
the offset distance is adjusted so that a depression angle to the nozzle from a horizontal line toward backward with respect to the flying direction of the vehicle is 60 degrees.

13. A chemical spraying unmanned aerial vehicle according to claim 12 wherein:
the depression angle was adjusted to a smaller angle as the flight speed of the vehicle is faster, or chemical discharge speed is higher.

14. A chemical spraying unmanned aerial vehicle according to claim 12 or claim 13 further comprising:
a mechanism for adjusting the depression angle according to the flying speed of the vehicle or chemical spraying speed.

15. A chemical spraying unmanned aerial vehicle according to claim 1, claim 2, claim 3, claim 4, claim 5, claim 6, claim 7, claim 8, claim 9, claim 10, claim 11, claim 12, claim 13 or claim 14 wherein:
plurality of spray nozzles are positioned at substantially equal intervals in a horizontal direction when viewed from the direction of travel of the vehicle.

16. A chemical spraying unmanned aerial vehicle according to claim 1, claim 2, claim 3, claim 4, claim 5, claim 6, claim 7, claim 8, claim 9, claim 10, claim 11, claim 12, claim 13, claim 14 or claim 15 further comprising:
a mechanism for controlling a direction of the vehicle such that first counter-rotating blades are always in front in the flying direction when the flying direction changes.
